(19) United States
(12) Patent Application Publication
(10) Pub. No.: US 2014/0352164 A1
(43) Pub. Date: Dec. 4, 2014

(54) Tape Measure with Measurement Indicia Dial

(71) Applicant: Scott Goldstein, Mashpee, MA (US)

(72) Inventor: Scott Goldstein, Mashpee, MA (US)

(21) Appl. No.: 14/094,818

(22) Filed: Dec. 3, 2013

Related U.S. Application Data
(60) Provisional application No. 61/830,993, filed on Jun. 4, 2013.

(51) Int. Cl. G01B 3/10

(52) U.S. Cl. CPC G01B 3/1061
USPC 33/701; 33/762

(57) ABSTRACT

A tape measure with a dial for storing a particular measurement value is provided. The present invention consists of a housing containing an extensible and retractable roll of measuring tape and a dial disposed on the outer face of the housing. The dial is used to store a measured value so that it can be remembered at a later time. Worksites are often noisy places filled with distractions, making it very easy to forget or misremember a measurement. When an individual forgets a measurement they are forced to either guess at the measurement value, potentially resulting in wasted materials and money, or re-measure the article, wasting valuable time. The present tape measure circumvents these problems by providing an easy and intuitive means for storing a numeric value while measuring so that it can be used for later without the user having to risk misremembering the value.

### CROSS REFERENCE TO RELATED APPLICATION

This application claims the benefit of U.S. Provisional Application No. 61/830,993 filed on Jun. 4, 2013, entitled “Measure-Once Tape Measure.” The above identified patent application is herein incorporated by reference in its entirety to provide continuity of disclosure.

### BACKGROUND OF THE INVENTION

1. Field of the Invention

The present invention relates to retractable tape measurement devices. More specifically, the present invention relates to retractable tape measurement devices that have a means for recording a measurement that the user wishes to recall at a later time.

Individuals on worksites, such as carpenters, often take measurements with a tape measure, but can become distracted or otherwise forget the measured value. Even if individuals intend to record a measurement using a writing device, it can be difficult to use a pen or pencil while in work gloves or find a writing utensil on a worksite. Even measurements that are written down may be misplaced, covered up, illegible, or in an inconvenient location on the worksite. Individuals often then try to cut materials based on the misremembered measurement, which can lead to wasted time, material, and money when they make a mistake. Ensuring that the given measurement is proper by constantly re-measuring lengths to make up for forgotten measurement values can be very time consuming and is not desirable.

Current devices attempt to solve the problem of misremembering a recently measured value by providing various means for recording the value measured by a tape measure. Some devices use an audio recording system whereby the user can make an audio recording and then playback said recording at a later time. Using these types of devices, individuals can make a measurement, record themselves saying the measurement out loud, and then play the recording back later to remind them of the measurement value. The effectiveness of these devices depends on the user being in an adequate audio recording environment, which is often not the case on a worksite. This renders tape measures with a means to record audio ineffective and not desirable in many circumstances. Other types of tape measures have internal computers and means of inputting a value into the computer for storage, but these designs are unnecessarily complicated. When a user simply wishes to measure something and then quickly and easily store that measurement for recall later, there is nothing easier than a simple dial that can be accessed intuitively. Furthermore, tape measures are often dropped or jostled because of their presence on a worksite, which can damage sensitive computer components.

The present invention solves all of these issues by providing a simple mechanical dial having a plurality of rotatable wheels and measurement indicia thereon. Because the dial is preferably placed near where the thumb naturally sits when holding the housing of the tape measure while making a measurement, it is very easy and intuitive to input the measured value immediately after the measurement is made. The chance that the correct number will be stored is increased compared to other devices because the dial is simple, intuitive, and can be used while the tape is extended or immediately thereafter, which decreases any risk of mistake. Furthermore, since the present tape measure with dial has a simple mechanical design, it can be built to be very sturdy and resistant to any damage that could disrupt the storage of the measurement value. Lastly, the present invention can store an individual measurement value regardless of the circumstances, such as the presence of continuous loud noise or the user wearing work gloves that could make it difficult to push small buttons.

2. Description of the Prior Art

Devices have been disclosed in the prior art that relate to tape measures with measurement recording systems. These include devices that have been patented and published in patent application publications. These devices generally relate to tape measures that are able to record audio or are integrated with computers. The following is a list of devices deemed most relevant to the present disclosure, which are herein described for the purposes of highlighting and differentiating the unique aspects of the present invention, and further highlighting the drawbacks existing in the prior art.

Two such devices are U.S. Pat. No. 5,396,578 to Howes and U.S. Pat. No. 5,802,732 to Malone, which both disclose a tape measurement device having an audio recording apparatus. Both Howes and Malone allow a user to record audio to be played back at a later time. The users are intended to record themselves saying the measurement value out loud so it can be played back to assist the users in remembering what the measured length was. Howes and Malone have a similar goal as the present invention in providing a way for the user to easily record and store a given number for recall at a later time, but do so in a very different way. Howes and Malone present an unneeded complication however by requiring that the individual make an audio recording for later playback. If the individual is in a poor audio recording environment, as is common on a work site, then he or she would be unable to record the number that he or she needs to remember for later because of the noise interference. The present invention allows the user to quickly and easily record a given number through the dial, which can be intuitively utilized by the user even in the middle of a high-noise environment.

Another such device is U.S. Pat. No. 5,983,514 to Lindsey, which discloses a tape measure that has an electronic keyboard for inputting and storing measurements to be viewed later. Lindsey has separate buttons to increment and decrement the displayed length, change the units of the length, save the number, and then to recall said number later. The present invention provides a much simpler system that is designed for intuitiveness, without sacrificing any accuracy. The present invention has a simple dial composed of four rotatable wheels that can be intuitively set by the user while in the process of measuring. Lindsey requires the user to take more steps in order to record a number and it does so through electronic means, rather than simpler and sturdier mechanical means as with the present invention.

Another such device is U.S. Pat. No. 6,658,755 to Arlinsky, which discloses a retractable tape measurement device that is capable providing the user with an indication of the angular orientation of the tape measure relative to a given orientation and transmitting one or more measurements to a remote device. Arlinksy provides a complicated system for recording and storing a plurality of measurements, but the present invention has a much simpler goal in assisting a user in remembering a single given measurement to be used shortly thereafter. Furthermore, the present invention has no means of communicating the stored measurement with a remote device. The present invention consists of a mechanical dial and has no computer-based interaction system.

Finally, U.S. Pat. No. 8,356,419 to Lord discloses a digital measuring tape comprising a housing having an LED display and a long, thin retractable wire, rather than traditional tape. The LED display shows the current distance the wire is extended and the measurements can be saved and recalled at a later time. Users can choose what form to display the measurements in and mathematical calculations can be performed on the device. While both inventions seek to assist users in remembering measurements that they are making, the present invention uses a four-wheel dial to input, store, and display the measurements, rather than a computer as in Lord.

The present invention provides a new and novel measuring tape device that has a dial, which allows users to easily record and store a measurement to be used at a later time. The present tape measure has a dial conveniently placed such that it is easily reachable by a user's thumb while they are in the process of making a measurement. This allows the user to instantly record the number, thereby reducing the risk that the user will forget the number. The present invention also utilizes a simple mechanical means to record the measurement, rather than an overly complex computer system that has additional unneeded features, when all the user wants to do is take a measurement and record that single number. It substantially diverges in design elements from the prior art and consequently it is clear that there is a need in the art for an improvement to existing tape measure devices. In this regard the instant invention substantially fulfills these needs.

### SUMMARY OF THE INVENTION

In view of the foregoing disadvantages inherent in the known types of tape measures now present in the prior art, the present invention provides a new tape measure with a dial wherein the same can be utilized for providing convenience for the user when storing a measurement while using a tape measure so that the measurement can be recalled at a later time.

It is therefore an object of the present invention to provide a new and improved tape measure device that has all of the advantages of the prior art and none of the disadvantages.

It is another object of the present invention to provide a tape measure device that can quickly and easily store a measurement value for recall at a later time.

Another object of the present invention is to provide a tape measure device that is sturdy and resistant to damage.

Yet another object of the present invention is to provide a tape measure device that has a dial with rotatable wheels with numerals depicted thereon.

Yet another object of the present invention is to provide a tape measure device that can store a measurement value for later recall in a noisy and chaotic worksite environment.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the dial face of the present invention.

FIG. 2 shows a perspective view of the reverse face of the present invention.

### DETAILED DESCRIPTION OF THE INVENTION

Reference is made herein to the attached drawings. Like reference numerals are used throughout the drawings to depict like or similar elements of the tape measure with dial. For the purposes of presenting a brief and clear description of the present invention, the preferred embodiment will be discussed as used for measuring and remembering measurements at a worksite. The figures are intended for representative purposes only and should not be considered to be limiting in any respect.

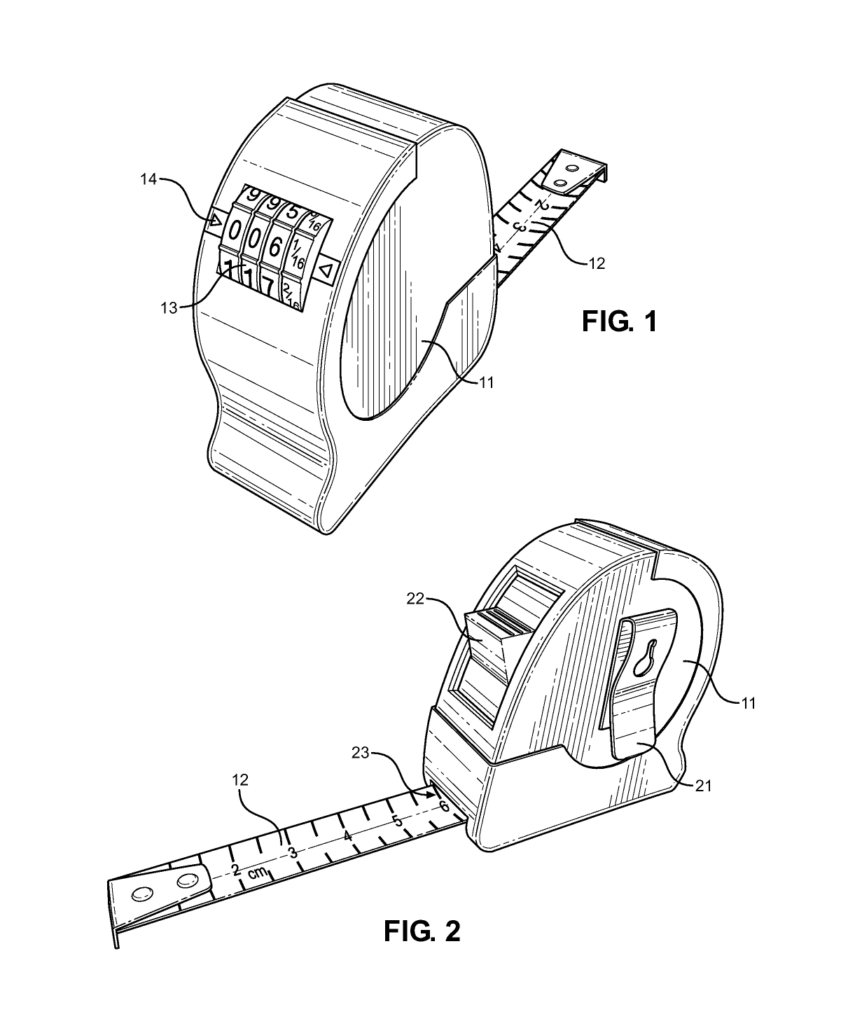

Referring now to FIG. 1, there is shown a perspective view of the dial face of the present invention. The present invention consists of a housing 11 having a plurality of sidewalls defining an interior volume containing an extensible and retractable roll of measuring tape 12. The measuring tape 12 has markings at regular intervals and numerals associated therewith to designate lengths. The housing 11 is preferably composed of sturdy material capable of withstanding the standard wear and tear associated with worksites without substantial damage. The housing 11 is depicted herein as having a front curved portion and a rounded back portion meeting at a base, but the depiction is merely exemplary and no claim is made as to the exact configuration or shape of the housing 11.

A dial 13 is disposed along the exterior face of the housing 11 for recording a particular length measurement. The dial 13 is preferably located along the back surface of the housing 11 such that it is easily accessible by the user's thumb through a window in the housing 11 while he or she is holding the measuring tape device while measuring an article. The back surface of the housing 11 is located opposite of the measuring tape aperture of the housing, whereby the dial is located wherein the user's thumb would naturally rest while measuring or dispensing the measuring tape. The dial 13 is preferably composed of four separate rotatable wheels with measurement indicia (numerals) depicted thereon. In the preferred embodiment the dial wheels have the numerals 0 to 9 depicted on the first three wheels, going left to right, in increments of 1 and the numerals 1/16″ to 15/16″ depicted on the fourth wheel in increments of 1/16″.

The wheels of the dial 13 need not have an equal number of numerals depicted thereon. For example, in the preferred embodiment the first three wheels have ten numerals depicting the numbers 0 to 9 and fifteen numerals depicting the measurements 1/16″ to 5/16″. The wheels are appropriately sized and have a sufficient number of faces to accommodate the potential difference in the number of numerals depicted thereon.

The wheels of the dial 13 can be rotated in order to display a single numeral depicted thereon at a time through the window in the housing 11. A dial arrow 14 can additionally be disposed on opposing sides of the dial 13 in order to provide an extra indicia indicating which number is intended to be saved by the user. The first, second, and third wheels of the preferred embodiment of the dial 13 represent, respectively, the hundreds, tens, and singles places of the stored number and the fourth wheel represents any remaining fractional value. This allows the user to store a huge number of potential permutations of measurements with little difficulty. The fractional value displayed on the final wheel of the dial 13 is preferably represented in sixteenths of an inch, but no claim is made as to that specific fractional value.

The wheels of the dial may be composed of any material that is sufficiently sturdy to avoid jarring if the device is dropped or otherwise impacted by a physical force. The present invention is designed to be used in worksite conditions and thus it is important that the device is capable of securely storing the measurement value because various types of physical impacts are quite likely. If the dials easily turned without input by the user, then the utility of the present tape measure would be greatly impacted.

Referring now to FIG. 2, there is shown a perspective view of the reverse face of the present invention. The toll of measuring tape 12 exits the interior volume of the housing 11 via the tape aperture 23. The measuring tape 12 can be both extended and retracted as the user wishes. The measuring tape 12 can be locked in place by engaging the tape lock 22. The tape lock 22 behaves as is commonly known in the prior art of tape measures. A belt clip 21 may also optionally be disposed along the exterior face of the housing 11 for ease of storage when the present invention is not in use.

In use, an individual first determines what length they would like to measure an article to and then inputs that length onto the dial of the present invention. The desired length can be determined, for example, by either measuring a corresponding article that the next article to be measured must match with, or in a number of other ways. The user inputs the pre-determined length by rotating the wheels of the dial around until the numeral depicted on each of the wheels together correspond the pre-determined number. The number is then saved on the exterior face of the device so that if the user forgets the length between when the particular number is determined and when the user goes to make his measurement, the saved number will serve as a reminder to avoid any potential mistakes or the need to re-determine the particular length. The user is then free to measure the present article with the dial serving as a reminder of the length. After the measurement is made, the user is free to rotate the dials to correspond to the next length to be measured and repeat the process. Overall, the present invention provides a novel and unique device for quickly and simply storing a single measurement value in order to avoid issues with forgetting or misremembering the given measurement.

Overall the present invention provides a tape measure that provides all of the features traditionally associated with tape measures, such as a retractable and extensible measurement tape, a locking mechanism, and a belt clip, combined with a simple means for recording measurements. The rotatable dial mechanism is designed to be user-friendly and simple to use on a worksite and if the user is wearing work gloves. The dial mechanism further provides an easy-to-read means storing individual measurements values for recall at a later time in a reusable manner.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tape measure for storing a single measurement value for recall at a later time, comprising:
a housing having a sidewall defining an interior volume;
a roll of measuring tape disposed within said interior volume;
a dial disposed along said sidewall having a plurality of rotatable dial wheels having indicia thereon.

2) The tape measure of claim 1, further comprising a belt clip disposed on said sidewall.

3) The tape measure of claim 1, wherein said dial has four rotatable dial wheels.

4) The tape measure of claim 3, wherein three of said rotatable dial wheels display indicia depicting the numerals 0 to 9 thereon and said fourth dial wheel displays indicia depicting the numerals 1/16″ to 15/16″ thereon.

5) The tape measure of claim 1, wherein said dial is positioned along a backside of said housing, said back surface being disposed opposite of a measuring tape dispensing aperture along said housing.

6) A method of measuring an article using the device of claim 1, comprising the steps of:
determining a desired length to measure;
inputting said desired length into said dial;
referencing said desired length input into said dial;
extending said roll of measuring tape until it is at said desired length.
